(19) United States
(12) Patent Application Publication
(10) Pub. No.: US 2012/0113123 A1
(43) Pub. Date: May 10, 2012

(54) METHOD, SYSTEM AND APPARATUS FOR PROCESSING CONTENT DATA AT A COMPUTING DEVICE

(75) Inventors: Robert Mori, Redwood City, CA (US); Dennis Emile Lembree, Redwood City, CA (US); Sumit Hasmukh Savla, Redwood City, CA (US); Thomas Jan Stovicek, Redwood City, CA (US); Carol C. Wu, Redwood City, CA (US)

(73) Assignee: RESEARCH IN MOTION LIMITED, Waterloo (CA)

(21) Appl. No.: 13/040,767

(22) Filed: Mar. 4, 2011

Related U.S. Application Data
(60) Provisional application No. 61/411,037, filed on Nov. 8, 2010.

(51) Int. Cl. G06T 11/20

(52) U.S. Cl. 345/441

(57) ABSTRACT

A method and apparatus for processing content data at a computing device is provided. Icon data associated with an application is rendered at a display device, thereby providing rendered icon data at the display device, the icon data and the application stored at a memory. Content data associated with the application is received the content data for rendering within the application when the application is executed by a processor and rendered at the display device. A portion of the rendered icon data is updated such that the rendered icon data comprises at least a subset of the content data. When the rendered icon data is actuated, the application is responsively executed at the processor such that the content data is rendered at the display device within a rendering of the application.

### CROSS REFERENCE TO RELATED APPLICATIONS

This application claims the benefit of Provisional Patent Application Ser. No. 61/411,037, filed on Nov. 8, 2010, said disclosure of which is hereby incorporated by reference herein in its entirety.

### FIELD

The specification relates generally to computing devices, and specifically to a method, system and apparatus for processing content data at a computing device.

### BACKGROUND

The evolution of computers is currently quite active in the mobile device environment. It is now well-known to including applications for accessing different types of content data in mobile devices. More recently, there has been a veritable explosion of the number and type of these applications that are configured to the unique form factors and computing environments of mobile devices.

### SUMMARY

An aspect of the specification provided a method for processing content data at a computing device, the computing device comprising a processor interconnected with a memory, a display device and a communication interface. The method comprises: rendering icon data associated with an application at the display device, thereby providing rendered icon data at the display device, the icon data and the application stored at the memory; receiving content data associated with the application, the content data for rendering within the application when the application is executed by the processor and rendered at the display device; updating a portion of the rendered icon data such that the rendered icon data comprises at least a subset of the content data; and when the rendered icon data is actuated, responsively executing the application at the processor such that the content data is rendered at the display device within a rendering of the application.

The application can remain unexecuted until the processor responsively executing the application step occurs.

The rendered icon data can comprise at least one of a header portion and a content portion; the portion of the rendered icon data that is updated can comprise the content portion. The header portion can be one of: static; or dynamic, such that content of the header can change based on the content data.

A shape of the rendered icon data can be one of: static; or dynamic, such that the shape can change based on at least one of the content data and time.

The content data can comprise at least one of HTML (hypertext markup language) data, HTML tags, text data and image data.

Receiving the content data can occur by at least one of: in response to a request for the content data transmitted to a content server via the communication interface; in a push operation of the content data from a content server via the communication interface; in an API (application programming interface); and a component of the computing device, wherein the component can comprise at least one of a GPS (Global Positioning System) device, an accelerometer, a light sensor, a compass sensor, an address book, a messaging application, a media application and a calendar application.

The content data can be received from a content server associated with an external service.

The method can further comprise storing the content data in a resource file associated with the application, such that the content data can be retrieved from the resource file when the application is executed.

A further aspect of the specification provides a computing device for processing content data, the computing device comprising: a processor interconnected with a memory, a display device and a communication interface, the processor enabled to: render icon data associated with an application at the display device, thereby providing rendered icon data at the display device, the icon data and the application stored at the memory; receive content data associated with the application, the content data for rendering within the application when the application is executed by the processor and rendered at the display device; update a portion of the rendered icon data such that the rendered icon data comprises at least a subset of the content data; and when the rendered icon data is actuated, responsively execute the application at the processor such that the content data is rendered at the display device within a rendering of the application.

The application can remains unexecuted until the processor responsively executes the application.

The rendered icon data can comprise at least one of a header portion and a content portion; the portion of the rendered icon data that is updated can comprise the content portion. The header portion can be one of: static; or dynamic, such that content of the header can change based on the content data.

A shape of the rendered icon data can be one of: static; or dynamic, such that the shape can change based on at least one of the content data and time.

The content data can comprise at least one of HTML (hypertext markup language) data, HTML tags, text data and image data.

The processor can be further enabled to receive the content data by at least one of: in response to a request for the content data transmitted to a content server via the communication interface; in a push operation of the content data from a content server via the communication interface; in an API (application programming interface); and via a component of the computing device, the component can comprise at least one of a GPS (Global Positioning System) device, an accelerometer, a light sensor, a compass sensor, an address book, a messaging application, a media application and a calendar application.

The content data can be received from a content server associated with an external service.

The processor can be further enabled to store the content data in a resource file associated with the application, such that the content data can be retrieved from the resource file when the application is executed.

Yet a further aspect of the specification provides a computer program product, comprising a computer usable medium having a computer readable program code adapted to be executed to implement a method for processing content data at a computing device, the computing device comprising a processor interconnected with a memory, a display device and a communication interface, the method comprising: rendering icon data associated with an application at the display device, thereby providing rendered icon data at the display device, the icon data and the application stored at the memory; receiving content data associated with the application, the content data for rendering within the application when the application is executed by the processor and rendered at the display device; updating a portion of the rendered icon data such that the rendered icon data comprises at least a subset of the content data; and when the rendered icon data is actuated, responsively executing the application at the processor such that the content data is rendered at the display device within a rendering of the application.

Icons are generally static representations of applications. When applications are provided with updates, the icon is actuated to launch the application in order to access details of the update in the application. In some cases, a notification icon (for example a star) is displayed, replacing the normal icon, to indicate that new content and/or an update is available. In other cases, a small notification icon, together with a number indicating a number of updates such as new e-mails, is displayed in a notification bar or status bar independent of an icon for launching the associated application, thereby indicating there is an update of interest. However, none of these solutions provide details of the content of the update.

### BRIEF DESCRIPTIONS OF THE DRAWINGS

For a better understanding of the various implementations described herein and to show more clearly how they may be carried into effect, reference will now be made, by way of example only, to the accompanying drawings in which:

FIG. 1 depicts a system including a computing device for processing content data, according to non-limiting implementations.

FIG. 2 depicts a subset of elements of the computing device of FIG. 1, according to non-limiting implementations.

FIG. 3 depicts flow diagram of a method for processing content data, according to non-limiting implementations.

FIG. 4 depicts a rendering of icon data prior to content data being processed, according to non-limiting implementations.

FIG. 5 depicts a system including a computing device for processing content data, according to non-limiting implementations.

FIG. 6 depicts the rendered icon data of FIG. 4 after content data is processed, according to non-limiting implementations.

FIG. 7 a perspective view of the computing device of FIG. 1, wherein icon data is rendered on a display device, according to non-limiting implementations.

FIG. 8 depicts the computing device of FIG. 7 after an application associated with icon data is executed upon actuation of the rendered icon data, according to non-limiting implementations.

FIGS. 9A and 9B respectively depict before and after views of rendered icon data wherein a header portion is dynamically changed after content data is processed, according to non-limiting implementations.

FIGS. 10A and 10B respectively depict before and after views of rendered icon data wherein a shape of the rendered icon data is dynamically changed after content data is processed, according to non-limiting implementations.

FIG. 11 depicts various “live” icons, according to non-limiting implementations.

### DETAILED DESCRIPTION OF THE IMPLEMENTATIONS

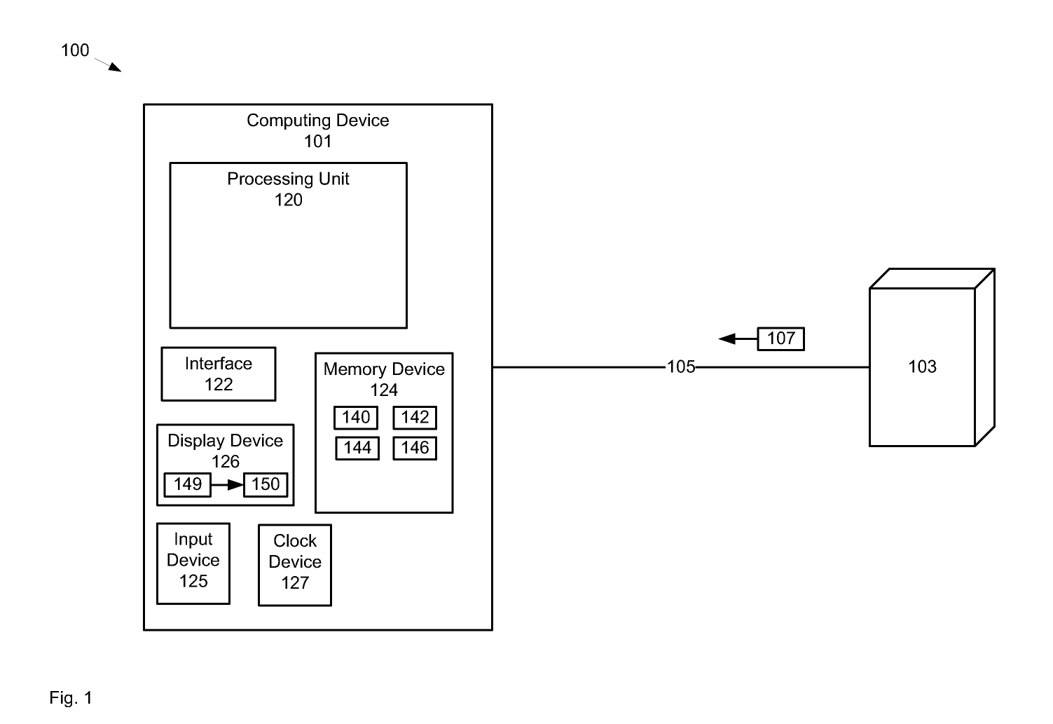

FIG. 1 depicts a system 100 for processing content data at a computing device a computing device 101, according to non-limiting implementations. In some implementations computing device 101 (also be referred to hereafter as device 101) is in communication with a server 103 via a link 105, content data 107 received from server 103 at device 101 via link 105 as will be explained below. Device 101 comprises a processing unit 120 interconnected with a communication interface 122, a memory device 124, an input device 125, and a display device 126, for example via a computing bus (not depicted). In some implementations device 101 can also comprise a clock device 127. Memory device 124 stores icon data 140, an application 142 associated with icon data 140 and further associated with content data 107. Memory device 124 further stores resource file 144, and content data 107 can be stored in resource file 144. Further, memory device 124 (also referred to hereafter as memory 124) stores an application 146 for updating an icon rendered at display device 126 using icon data 140, as will be described below.

In general, device 101 comprises any suitable electronic device for processing icon data 140, applications 142, 146, resource file 144 and content data 107, including but not limited to any suitable combination of computing devices, desktop computing devices, laptop computing devices, portable computing device, mobile electronic devices, PDAs (personal digital assistants), cellphones, smartphones and the like. Other suitable electronic devices are within the scope of present implementations.

Server 103 can be based on any well-known server environment including a module that houses one or more central processing units, volatile memory (e.g. random access memory), persistent memory (e.g. hard disk devices) and network interfaces to allow server 103 to communicate over link 105. For example, server 103 can be a ProLiant® Server from Hewlett-Packard Company, 3000 Hanover Street Palo Alto, Calif. 94304-1185 USA having a plurality of central processing units and having several gigabytes of random access memory. However, it is to be emphasized that this particular server is merely a non-limiting example, and a vast array of other types of computing environments for server 103 is contemplated. Furthermore, it is contemplated that server 103 may be implemented as a plurality of interconnected servers, in a so-called server farm, which are mirrored or otherwise configured for load balancing or failover or high availability or any or all of those.

It is yet further contemplated that system 100 can comprise a plurality of servers (not depicted) similar to server 103, each server in the plurality of servers providing content data for different applications similar to application 142. Indeed, it is contemplated that icon 140, application 142 and resource file 144 can each respectively be one of a plurality of associated icons, applications and sets of resource file for processing and/or rendering content data from respective servers.

Link 105 comprises any suitable link between device 101 and server 103, including any suitable combination of wired and/or wireless links, wired and/or wireless devices and/or wired and/or wireless networks, including but not limited to any suitable combination of including but not limited to wired link, USB (universal serial bus) cables, serial cables, wireless links, cell-phone links, wireless data, Bluetooth links, NFC (near field communication) links, WiFi links, WiMax links, packet based links, the Internet, analog networks, the PSTN (public switched telephone network), access points, and the like, and/or a combination. Other suitable communication link and/or devices and/or networks are within the scope of present implementations.

With regard to device 101, processing unit 120 (also referred to hereafter as processor 120) comprises any suitable processor, or combination of processors, including but not limited to a microprocessor, a central processing unit (CPU) and the like. Other suitable processing units are within the scope of present implementations. It is appreciated that processing unit 120 is enabled to process icon data 140, applications 142, 146, resource file 144 and content data 107. Further processor 100 can be enabled to execute different programming instructions that can be responsive to the input received via input devices and/or upon receipt of content data 107.

Communication interface 122 comprises any suitable communication interface, or combination of communication interfaces. In particular communication interface 122 is enabled to communicate with server 103 via link 105 using any suitable wired and/or wireless protocol. Accordingly, communication interface 122 (which will also be referred to as interface 122 hereafter) is enabled to communicate according to any suitable protocol which is compatible with link 105, including but not limited to wired protocols, USB (universal serial bus) protocols, serial cable protocols, wireless protocols, cell-phone protocols, wireless data protocols, Bluetooth protocols, NFC (near field communication) protocols, packet based protocols, Internet protocols, analog protocols, PSTN (public switched telephone network) protocols, WiFi protocols, WiMax protocols and the like, and/or a combination. Other suitable communication interfaces and/or protocols are within the scope of present implementations.

Input device 125 is generally enabled to receive input data, and can comprise any suitable combination of input devices, including but not limited to a keyboard, a keypad, a pointing device, a mouse, a track wheel, a trackball, a touchpad, a trackpad, a touch screen and the like. Other suitable input devices are within the scope of present implementations.

Memory device 124 can comprise any suitable memory device, including but not limited to any suitable one of, or combination of, volatile memory, non-volatile memory, random access memory (RAM), read-only memory (ROM), Erase Electronic Programmable Read Only Memory (EEPROM), Flash Memory hard drive, optical drive, flash memory, magnetic computer storage devices (e.g. hard disks, floppy disks, and magnetic tape), optical discs, removable memory, and the like. Other suitable memory devices are within the scope of present implementations. In particular, memory device 124 is enabled to store icon data 140, applications 142, 146 and resource file 144.

Display device 126 comprises circuitry 149 for generating renderings of data, for example a rendering 150 of at least one of icon data 140 and application 146, as will be described below. Display device 126 can include any suitable one of or combination of CRT (cathode ray tube) and/or flat panel displays (e.g. LCD (liquid crystal display), plasma, OLED (organic light emitting diode), capacitive or resistive touchscreens, and the like). Circuitry 149 can include any suitable combination of circuitry for controlling the CRT and/or flat panel displays etc., including but not limited to display buffers, transistors, electron beam controllers, LCD cells, plasmas cells, phosphors etc. In particular, display device 126 and circuitry 149 can be controlled by processing unit 120 to generate rendering 150.

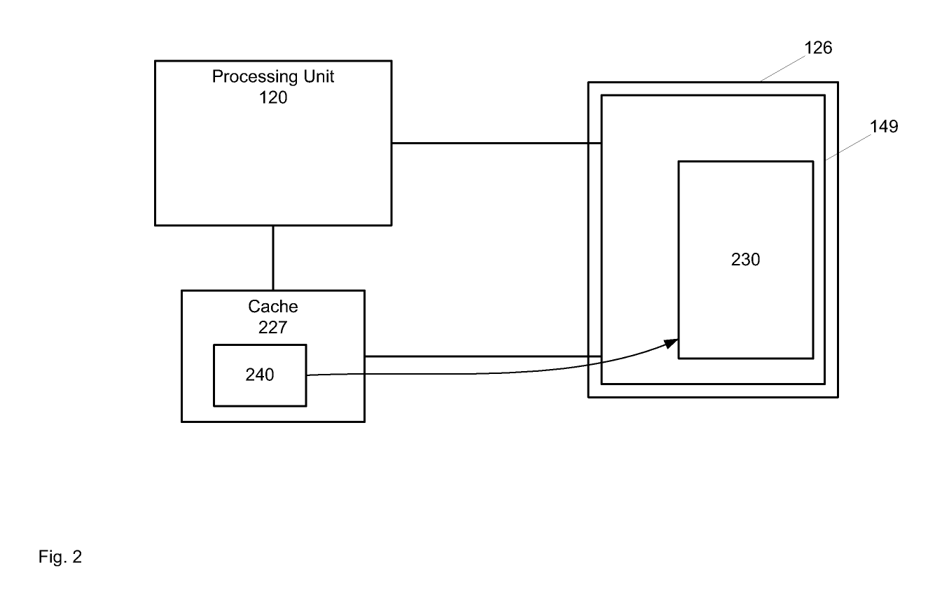

In particular, attention is directed to FIG. 2 which depicts non-limiting implementations of display device 126 and circuitry 149, in communication with processing unit 120 and a memory cache 227 (hereinafter cache 227). In some implementations, memory device 124 can comprise cache 227, while in other implementations cache 227 can comprise a separate memory device. Furthermore, processing unit 120 is in communication with cache 227 and further enabled to control circuitry 149. In particular, processing unit is enabled to control an area 230 of circuitry 149 to provide rendering 150. Data 240 is stored in cache 227, data 240 comprising data for controlling area 230 to provide rendering 150; when rendering 150 is to be provided at display 126, data 240 is transferred to display 126 to control circuitry 230.

In implementations depicted in FIG. 2, it is appreciated that circuitry 149 and area 230 comprises, for example, transistors in a flat panel display; however, in other implementations, circuitry 149 can comprise a combination of an electron gun in a CRT, and area 230 can comprise phosphors in a CRT.

In some implementations device 101 further comprises a clock device 127, comprising any suitable electronic and/or digital clock device. It is appreciated that processor 120 is interconnected with clock device 127 (e.g. via a computer bus, not depicted) such that processor 120 can retrieve times and/or dates from clock device 127 and thereby determine when a given time period has passed.

In some implementations, device 101 can further comprise any suitable combination of other hardware and/or software components, including but not limited to a GPS (Global Positioning System) device, an accelerometer, a light sensor, a compass sensor, an address book, a messaging application, a media application a calendar application, and the like.

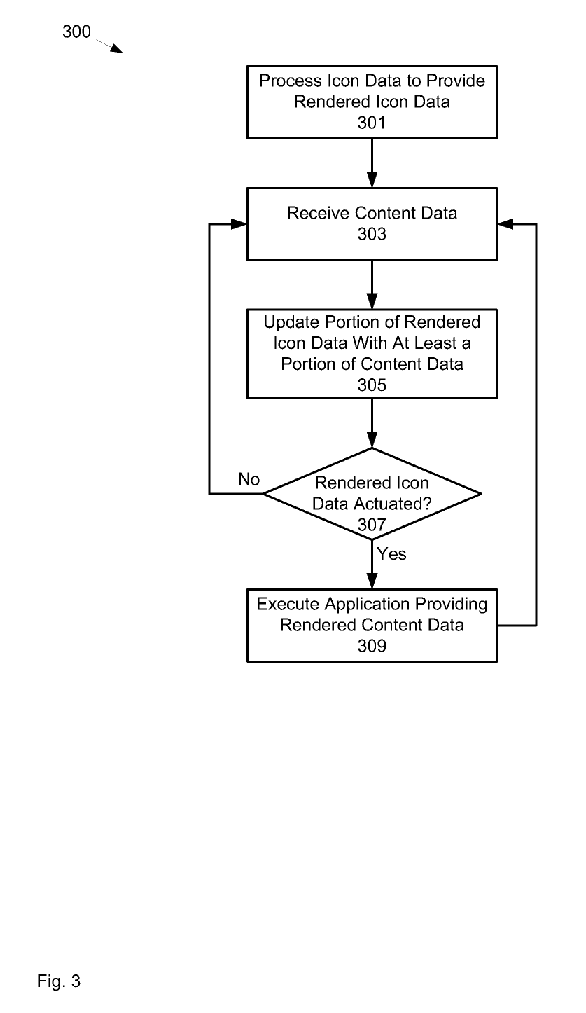

Attention is now directed to FIG. 3 which depicts a flow-chart of a method 300 for processing content data at a computing device. In order to assist in the explanation of method 300, it will be assumed that method 300 is performed using system 100. Furthermore, the following discussion of method 300 will lead to a further understanding of system 100 and its various components. However, it is to be understood that system 100 and/or method 300 can be varied, and need not work exactly as discussed herein in conjunction with each other, and that such variations are within the scope of present implementations.

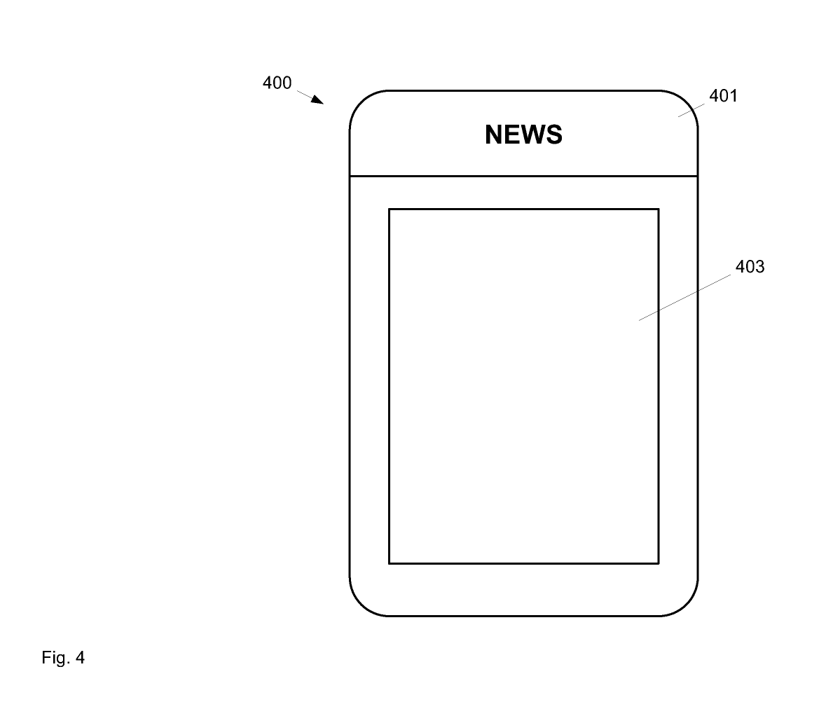

At block 301, icon data 140 associated with application 140 is rendered at display device 126, thereby providing rendered icon data 400 at display device 126. A non-limiting implementation of rendered icon data 400, also referred to hereafter as icon 400, is depicted in FIG. 4. In some implementation rendering 150 comprises icon 400. It is appreciated that icon 400 can comprise a header portion 401 and a content portion 403. It is further appreciated that header portion 401 comprises an identifier of associated application 142 and/or an identifier of a type of content data 107: for example, as depicted in FIG. 4, header portion 401 comprises the text “News”, indicating that when icon 400 is actuated (e.g. via input device 125) a “News” application will be launched by executing application 142 (i.e. application 142 can comprise a news application) and news content will be provided therein.

Content portion 403 is enabled to provide at least a subset of content data 107. However, as content data 107 has not yet been received, in FIG. 4 content portion 403 is not populated. Hence, in FIG. 4, icon 400 appears similar to a static icon of the prior art.

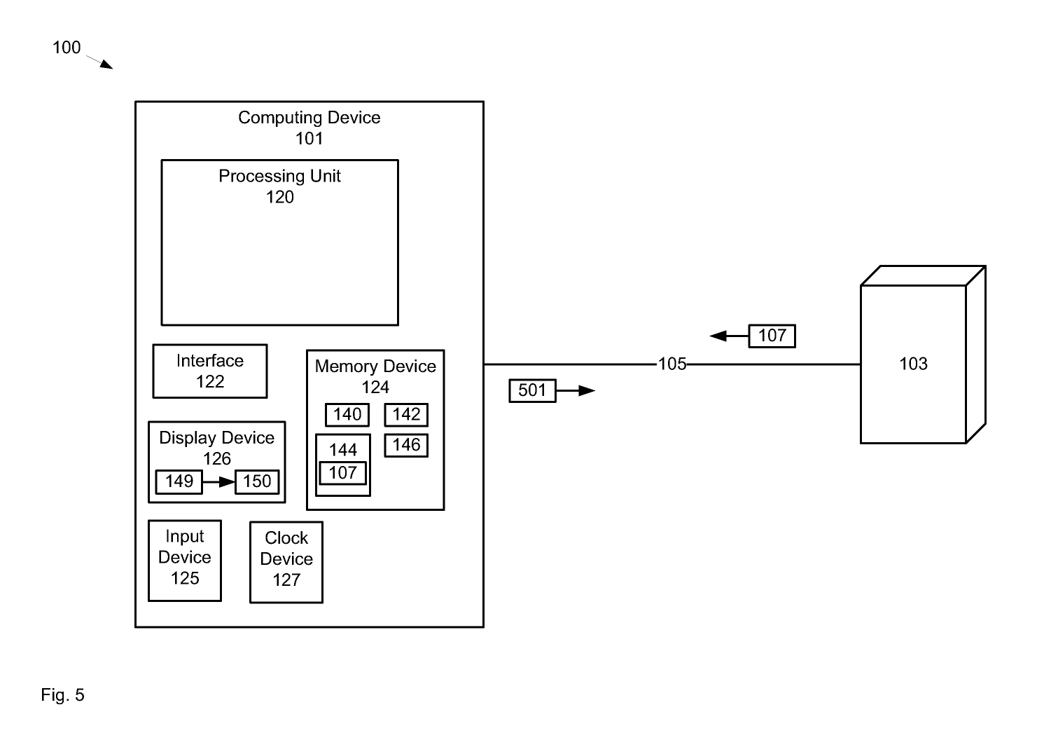

Returning to FIG. 3, at block 303 content data 107 is received. In some implementations content data 107 is received in response to device 101 transmitting a request 501 to server 103 via interface 122 and/or link 105. For example, application 146 (and/or any other suitable application) can be enabled to periodically request updates from server 103. Server 103 responds to request 501 by transmitting content data 107 to device 101 vi link 105, as depicted in FIG. 5 (substantially similar to FIG. 1, with like elements having like numbers).

However, in other implementations content data 107 can be received in a push operation of content data 107 from server via communication interface 122. For example server 103 can be enabled to transmit content data 107 periodically and/or as changes occur to data monitored and/or stored by server 103. It is contemplated, for example, that server 103 can be enabled to electronically monitor a stock price; when the stock price changes, content data 107 is transmitted to device 101. Any other trigger for transmitting and/or pushing content data 107 to device 101 is within the scope of present implementations.

Further, in some implementations, content data 107 can be received from a server associated with an external service. For example, whether in push implementations or on implementations where content data 107 is requested by device 101, server 103 can retrieve content data 107 from another server (not depicted) associated with an external service, such as news service, a stock exchange, or the like.

In yet further implementations, content data 107 can be received from at least one hardware and/or software component of device 101, including but not limited to at least one of a GPS (Global Positioning System) device, an accelerometer, a light sensor, an address book, a messaging application, a calendar application and the like. In some of these implementations, components of device 101 can be accessed via an API (application programming interface).

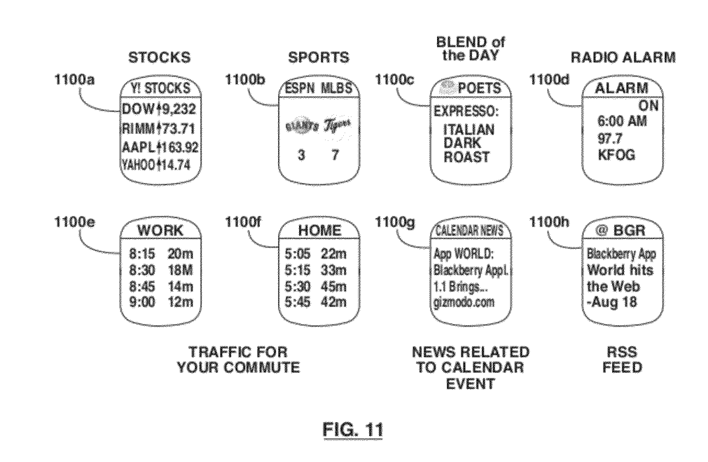

In yet further implementations, content data 107 can be received from input device 125. For example in implementation where application 142 comprises an alarm clock application, a time to trigger the alarm clock application (e.g. to provide an alarm) can be received from input device 125, as well as any other suitable data, such as a radio station to tune to provide as the alarm (e.g. see icon 1100d described below with reference to FIG. 11).

It is yet further appreciated that content data 107 is associated with application 142 and that content data 107 can be rendered within application 142 when application 142 is executed by processor 120 and rendered at display device 126. For example, returning to the example of application 142 comprising a news application, content data 107 can comprise news data for display in the news application once news application is executed by processor 120 and rendered at display device 126.

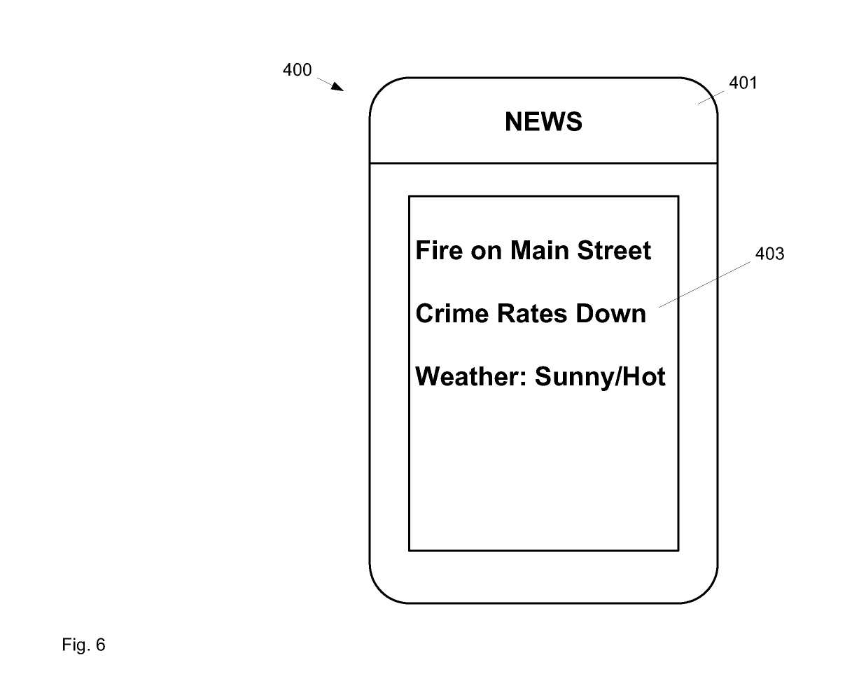

Returning now to FIG. 3, at block 305 a portion of rendered icon data 400 is updated such that rendered icon data 400 comprises at least a subset of content data 107. With reference to FIG. 6, which is substantially similar to FIG. 4 with like elements having like numbers, in some implementations, content portion 403 of icon 400 is updated with at least a subset of content data 107. For example, content data 107 can comprise text such as “NEWS FOR APR. 27, 2010, HEADLINES: Fire on Main Street, Crime Rates Down, Weather Sunny/Hot”, followed by each story indicated in the headlines. However only the headlines are provided in content portion 403 of icon 400 and the other data is not provided. Rather, content data 107 is stored in resource file 144 for later access by application 142, as depicted in FIG. 5. For example, content data 107 can be stored in resource file 144, such that content data 107 can be retrieved from resource file 144 when application 142 is executed by processor 120.

In some implementations, content data 107 comprises HTML (Hypertext Markup Language) data intended for display in application 142, and tags in the HTML data can be used to determine which portion of content data 107 is provided in icon 400. However content data 107 can comprise any suitable format, and the format of content data 107 is not to be considered particularly limiting. Content data 107 can further comprise any suitable combination of text, images, or the like, each in any suitable format.

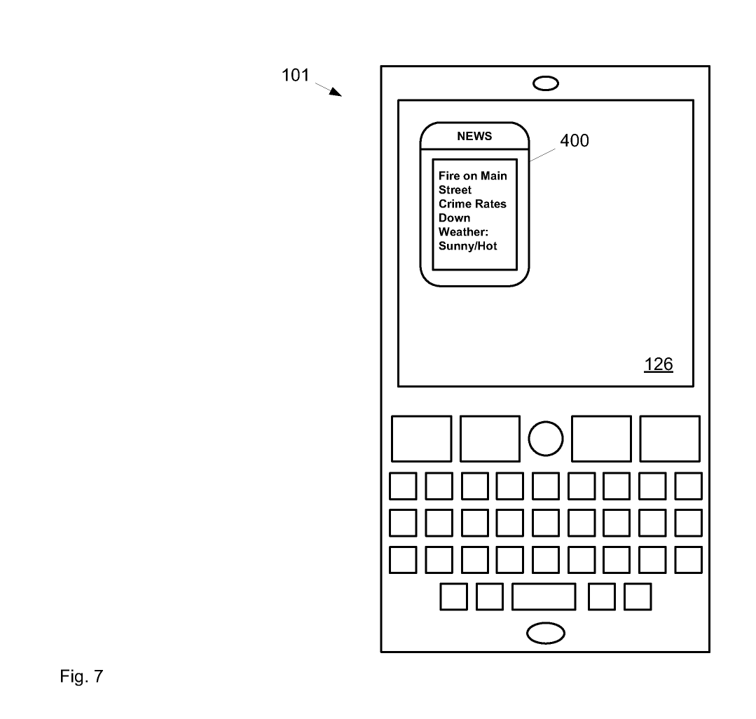

Attention is now directed to FIG. 7, which depicts a perspective view of device 101 with icon 400 rendered at display device 126. It is further appreciated that icon 400 can be provided on a home screen of device 101, such that icon 400 is generally provided unless an application and/or a screen other than a home screen is being provided.

It is appreciated that in FIG. 7, icon 400 is providing at least a portion of content data 400 and that full content data 107 can be provided in application 142 upon actuation of icon 400. Specifically, returning to FIG. 3, at block 307 it is determined whether icon 400 has been actuated. If not, further content data can be received at block 303 as described above, and icon 400 can be updated again at block 305. Indeed, blocks 303 and 305 can be repeated any suitable number of times until it is determined at block 307 that icon 400 has been actuated.

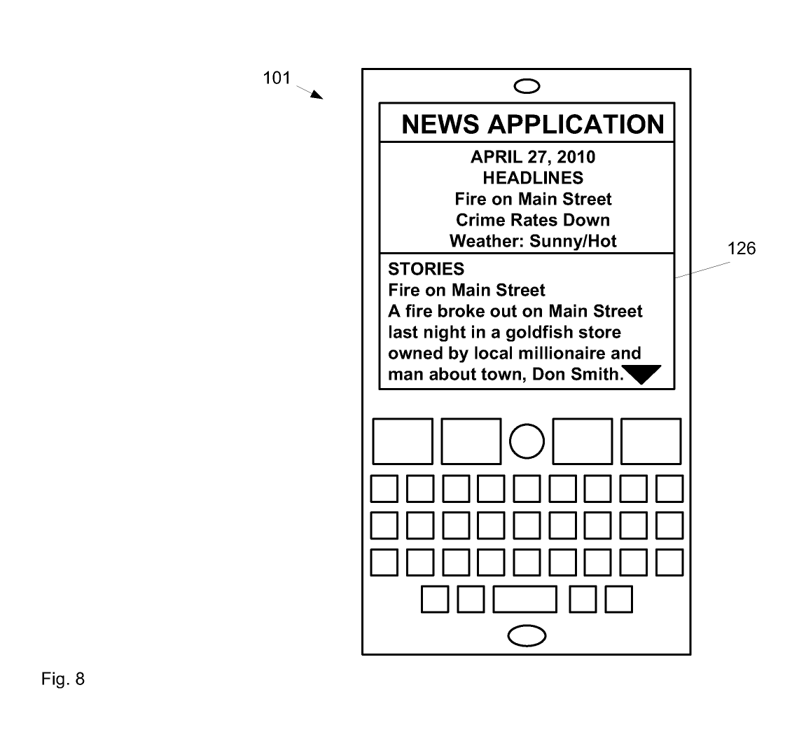

When icon 400 is actuated, at block 309, application 142 is responsively executed at processor 120 such that content data 107 is rendered at display device 126 within a rendering of application 142, as depicted in FIG. 8. FIG. 8 is substantially similar to FIG. 7 with like elements having like numbers, however in FIG. 8 icon 400 has been actuated, application 142 has been executed, content data 107 has been retrieved from resource file 144, and application 142 and content data 107 have been rendered at display device 126.

It is appreciated that application 142 remains unexecuted until icon 400 is actuated. In other words, rendering of icon 400, and rendering of at least a portion of content data 107 in icon 400 can occur independently of execution of application 142.

However, in further implementations, application 142 rendering of icon 400, and/or rendering of at least a portion of content data 107 in icon 400 can occur while application 142 is being executed in the background (e.g. processed by processor 120 but not rendered at display device 126), in the foreground, or the like.

It is further appreciated that blocks 303 to 307 are repeated there after, and that application 142 can thereafter be closed, minimized, or the like. Indeed, it is appreciated that in some implementations, blocks 303 to 307 can be repeated independent of whether or not application 142 is closed and/or minimized, and/or whether or not application 142 remains open.

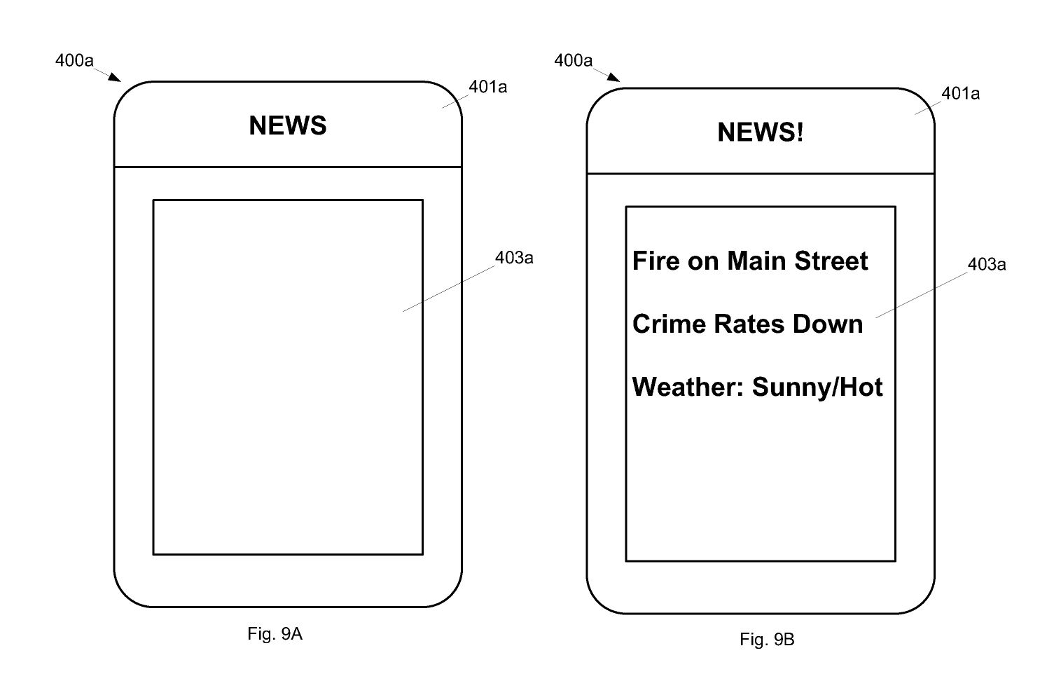

In some implementations, header portion 401 is static and does not change when content portion 403 is updated, for example as depicted in FIGS. 4, 6 and 7. However, in other implementations, header portion 401 is dynamic, such that content of header portion 401 changes based on content data 107. For example, FIG. 9A depicts an icon 400a similar to icon 400, with like elements having like numbers with an “a” appended thereto. However, header portion 400a is dynamic. For example, FIG. 9B depicts icon 400a once content data 107 has been received. It is appreciated that content portion 403a has been updated similar to icon 400 in FIG. 6. However, it is further appreciated header portion 401a has also been updated from “NEWS” to “NEWS!”, thereby indicating that content portion 403a has been updated. In some implementations, after a given time period, header portion 401a can return to the state depicted in FIG. 9A when no new content data 107 is received and/or when no new content portion 403a has been received in the given time period.

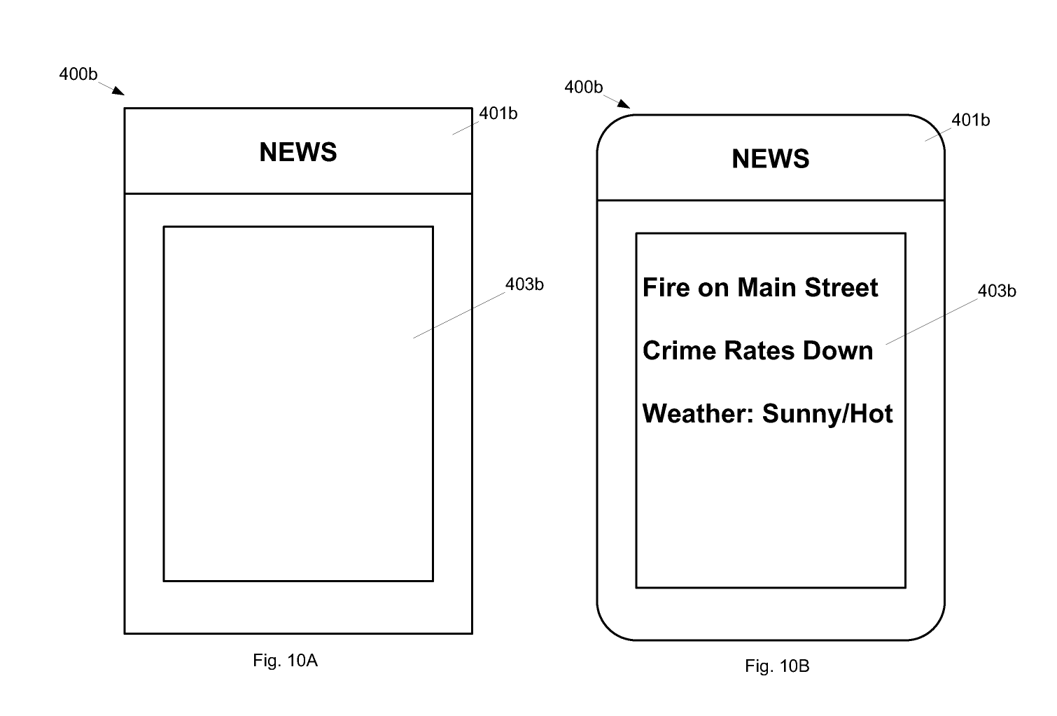

In some implementations, the shape of icon 400 is static. However, in other implementations, the shape of icon 400 is dynamic, such that content of header portion 401 changes based on content data 107, and/or with time. For example, FIG. 10A depicts an icon 400b similar to icon 400, with like elements having like numbers with a “b” appended thereto. However, the shape of icon 400 is dynamic. For example, it is appreciated that icon 400b has square corners. However, once content data 407 is received and/or content portion 403b is updated, the corners of icon 400b change to rounded corners as in FIG. 10B. In some implementations, after a given time period, the shape of icon 400b can change back to square corners, either abruptly or slowly (e.g. in an animation) indicating that the content of content portion 403b is no longer fresh. Indeed, any change in shape and/or type of change and/or mechanism for changing shape of icon 400b is within the scope of present implementations.

It is further appreciated that method 300 can be repeated for any suitable number of icons and associated applications such that any suitable number of icons that are updated to provide content data from the same or different server and/or from components at device 101 are rendered at display device 126.

For example, FIG. 11 depicts non-limiting examples of different icons 1100a-1100h that can be rendered at display device 126. Each of icons 1100a-1100h is similar to icon 400 but associated with different applications stored in memory 124. Further, each icon 1100a-1100h is updated as respective associated content data is received; and each respective associated application is launched when the respective icon 1100a-1100h is actuated. For example, icon 1100a is associated with a stock application and stock data is provided in icon 1100a, the stock application being launched when icon 1100a is actuated. Icon 1100b is associated with a sports application and sports data is provided in icon 1100b, the sports application being launched when icon 1100b is actuated. Icon 1100c is associated with an application showing products available at a coffee shop (e.g. “Blend of the Day”) and product data is provided in icon 1100c, the coffee shop application being launched when icon 1100c is actuated. Icon 1100d is associated with an alarm clock application and alarm data is provided in icon 1100d, the alarm clock application being launched when icon 1100d is actuated; it is appreciated in this implementation that the associated content data can be received from an API and/or a component of device 101 and/or data stored in device 101. Icons 1100e and 1100f are each associated with a traffic application that provides estimated commute times for going to work and returning home from work, the estimated commute times provided in icon 1100a, the traffic application being launched when either of icon 1100e or 1100f is actuated. Icon 1100g is associated with a news application related to calendar events and news data is provided in icon 1100g, the news application being launched when icon 1100g is actuated. Icon 1100h is associated with an RSS (Really Simple Syndication) application and RSS data is provided in icon 1100h, the RSS application being launched when icon 1100h is actuated.

Any other types of icons and associated applications are within the scope of present implementations. In a non-limiting example, a GPS device could determine location and present associated content in an icon similar to icon 400, such as “You Are Now Home” in the icon: i.e. an indication of current location is provided.

In yet a further non-limiting example, an icon associated with a telephone application could be provided; another associated address book and/or e-mail monitoring application could be enabled to keep track of e-mail addresses to which messages are most often sent, and the icon could present a phone number associated with the most often mailed e-mail address; actuation of the icon could then launch the phone application, dialing the provided number. Hence, in this implementation content data is received from another application at device 101 and stored in an associated resource file.

Indeed, such coupling to other applications is also contemplated. For example, an e-mail monitoring application and/or an RSS feed (or news) monitoring application could be enabled to monitor accessed and/or stored content at device 101, and an icon associated with a phone application and/or a news application could be updated based on the monitored data. In other words content data is received from the coupled application. For example, the monitoring application could determine that many e-mails complaining about an oil spill have received/transmitted and/or the monitoring application could determine that RSS feeds or news content is being accessed about the oil spill. In response, the monitoring application could determine the phone number of a politician to which complaints could be sent and provide content data comprising the e-mail address and/or phone number of the politician, Hence, upon actuation of the icon, a messaging and/or phone application could be launched providing access to the politician via e-mail and/or phone.

Various advantages will now be apparent. For example, rendering of content data in “live” icons, such as icon 400 provides a convenient means of accessing content data delaying launch of the associated application until the provided content data indicates a need to launch the associated application, for example to access more details of the provided content data. This can lead to a reduction in processing resources at device 101, as well as an increase in battery life as processing of applications is generally more resource intensive than updating of icons as described herein. Furthermore, more efficient use of cache 227 due to delaying launch of the associated application as the associated application will generally consume more of cache 227 resources.

Those skilled in the art will appreciate that in some implementations, the functionality of device 101 can be implemented using pre-programmed hardware or firmware elements (e.g., application specific integrated circuits (ASICs), electrically erasable programmable read-only memories (EEPROMs), etc.), or other related components. In other implementations, the functionality of device 101 can be achieved using a computing apparatus that has access to a code memory (not shown) which stores computer-readable program code for operation of the computing apparatus. The computer-readable program code could be stored on a computer readable storage medium which is fixed, tangible and readable directly by these components, (e.g., removable diskette, CD-ROM, ROM, fixed disk, USB drive). Furthermore, it is appreciated that the computer-readable program can be stored as a computer program product comprising a computer usable medium. Further, a persistent storage device can comprise the computer readable program code. It is yet further appreciated that the computer-readable program code and/or computer usable medium can comprise a non-transitory computer-readable program code and/or non-transitory computer usable medium. Alternatively, the computer-readable program code could be stored remotely but transmittable to these components via a modem or other interface device connected to a network (including, without limitation, the Internet) over a transmission medium. The transmission medium can be either a non-mobile medium (e.g., optical and/or digital and/or analog communications lines) or a mobile medium (e.g., microwave, infrared, free-space optical or other transmission schemes) or a combination thereof.

A portion of the disclosure of this patent document contains material which is subject to copyright protection. The copyright owner has no objection to the facsimile reproduction by any one the patent document or patent disclosure, as it appears in the Patent and Trademark Office patent file or records, but otherwise reserves all copyrights whatsoever.

Persons skilled in the art will appreciate that there are yet more alternative variations and modifications possible for present implementations, and that the above implementations and examples are only illustrations of one or more implementations.

What is claimed is:

1. A method for processing content data at a computing device, said computing device comprising a processor interconnected with a memory, a display device and a communication interface, the method comprising:
rendering icon data associated with an application at said display device, thereby providing rendered icon data at said display device, said icon data and said application stored at said memory;
receiving content data associated with said application, said content data for rendering within said application when said application is executed by said processor and rendered at said display device;
updating a portion of said rendered icon data such that said rendered icon data comprises at least a subset of said content data; and
when said rendered icon data is actuated, responsively executing said application at said processor such that said content data is rendered at said display device within a rendering of said application.

2. The method of claim 1, wherein said application remains unexecuted until said processor responsively executing said application.

3. The method of claim 1, wherein said rendered icon data comprises at least one of a header portion and a content portion; said portion of said rendered icon data that is updated comprising said content portion.

4. The method of claim 3, wherein said header portion is one of:
static; or
dynamic, such that content of said header changes based on said content data.

5. The method of claim 1, wherein a shape of said rendered icon data is one of:
static; or
dynamic, such that said shape changes based on at least one of said content data and time.

6. The method of claim 1, wherein said content data comprises at least one of HTML (hypertext markup language) data, HTML tags, text data and image data.

7. The method of claim 1, wherein said receiving said content data occurs by at least one of:
in response to a request for said content data transmitted to a content server via said communication interface;
in a push operation of said content data from a content server via said communication interface;
in an API (application programming interface); and
a component of said computing device, said component comprising at least one of a GPS (Global Positioning System) device, an accelerometer, a light sensor, a compass sensor, an address book, a messaging application, a media application and a calendar application.

8. The method of claim 1, wherein said content data is received from a content server associated with an external service.

9. The method of claim 1, further comprising storing said content data in a resource file associated with said application, such that said content data can be retrieved from said resource file when said application is executed.

10. A computing device for processing content data, the computing device comprising:
a processor interconnected with a memory, a display device and a communication interface, the processor enabled to:
render icon data associated with an application at said display device, thereby providing rendered icon data at said display device, said icon data and said application stored at said memory;
receive content data associated with said application, said content data for rendering within said application when said application is executed by said processor and rendered at said display device;
update a portion of said rendered icon data such that said rendered icon data comprises at least a subset of said content data; and
when said rendered icon data is actuated, responsively execute said application at said processor such that said content data is rendered at said display device within a rendering of said application.

11. The computing device of claim 10, wherein said application remains unexecuted until said processor responsively executes said application.

12. The computing device of claim 10, wherein said rendered icon data comprises at least one of a header portion and a content portion; said portion of said rendered icon data that is updated comprising said content portion.

13. The computing device of 12, wherein said header portion is one of:
static; or
dynamic, such that content of said header changes based on said content data.

14. The computing device of claim 10, wherein a shape of said rendered icon data is one of:
static; or
dynamic, such that said shape changes based on at least one of said content data and time.

15. The computing device of claim 10, wherein said content data comprises at least one of HTML (hypertext markup language) data, HTML tags, text data and image data.

16. The computing device of claim 10, wherein said processor is further enabled to receive said content data by at least one of:
in response to a request for said content data transmitted to a content server via said communication interface;
in a push operation of said content data from a content server via said communication interface;
in an API (application programming interface); and
via a component of said computing device, said component comprising at least one of a GPS (Global Positioning System) device, an accelerometer, a light sensor, a compass sensor, an address book, a messaging application, a media application and a calendar application.

17. The computing device of claim 10, wherein said content data is received from a content server associated with an external service.

18. The computing device of claim 10, wherein said processor is further enabled to store said content data in a resource file associated with said application, such that said content data can be retrieved from said resource file when said application is executed.

19. A computer program product, comprising a computer usable medium having a computer readable program code adapted to be executed to implement a method for processing content data at a computing device, said computing device comprising a processor interconnected with a memory, a display device and a communication interface, the method comprising:
rendering icon data associated with an application at said display device, thereby providing rendered icon data at said display device, said icon data and said application stored at said memory;
receiving content data associated with said application, said content data for rendering within said application when said application is executed by said processor and rendered at said display device;
updating a portion of said rendered icon data such that said rendered icon data comprises at least a subset of said content data; and
when said rendered icon data is actuated, responsively executing said application at said processor such that said content data is rendered at said display device within a rendering of said application.
